(19) United States
(12) Patent Application Publication
(10) Pub. No.: US 2003/0185299 A1
(43) Pub. Date: Oct. 2, 2003

(54) Program, recording medium, and image encoding apparatus and method

(76) Inventor: Taro Takita, Tokyo (JP)

Correspondence Address: William S. Frommer, Esq., FROMMER LAWRENCE & HAUG LLP, 745 Fifth Avenue, New York, NY, 10151, US

(21) Appl. No.: 10/306,380

(22) Filed: Nov. 27, 2002

(30) Foreign Application Priority Data
Nov. 30, 2001 (JP) 2001-367142

(51) Int. Cl. H04N 7/12

(52) U.S. Cl. 375/240.03; 375/240.24; 375/240.08

(57) ABSTRACT

The invention is intended to provide images with stable quality for all the types of pictures. A generated code rate ratio of a picture to be now encoded is computed depending on the picture type (generated code rate computing step). Based on the generated code rate, an imaginary buffer occupancy rate for a j-th macro block MB(j) is computed (imaginary buffer occupancy rate computing step). A common imaginary buffer is employed regardless of the picture type. Based on the imaginary buffer occupancy rate, a quantization scale code for MB(j) is computed (quantization scale code computing step). When processing of the last MB of the relevant picture is completed, the imaginary buffer occupancy rate for the last MB is set as an initial value of the imaginary buffer occupancy rate for a picture to be next encoded (initial value setting step).

### BACKGROUND OF THE INVENTION

1. Field of the Invention

The present invention relates to a program, a storage medium, and an image encoding apparatus and method. More particularly, the present invention relates to a program, a recording medium, and an image encoding apparatus and method, which enable images with stable quality to be provided for all the types of pictures.

2. Description of the Related Art

Recently, the image compression technology represented by MPEG (Moving Picture Experts Group) has been developed.

In the MPEG image compression scheme, an image of each frame is predicted in any of prediction modes, e.g., I picture (Intra-Picture), P picture (Predictive-Picture) or B picture (Bidirectionally Predictive-Picture), and a predictive error is encoded.

Image data of the I picture is image data (intra-encoded image data) resulting from encoding image data for one frame, as it is, without utilizing image data of any other frame. Image data of the P picture is basically image data (inter-frame forward predictive encoded image data) resulting from encoding differences from image data of the I picture or the P picture that precedes the relevant P picture in time. Further, image data of the B picture is basically image data (inter-frame bidirectionally predictive encoded image data) resulting from encoding differences from image data of the I picture or the P picture that precedes the relevant B picture in time, or from image data of the I picture or the P picture that succeeds to the relevant B picture in time.

Thus, according to the MPEG scheme, because only the predictive errors are encoded, the data amount (rate) can be reduced in comparison with case of encoding image data of each frame as it is.

In a conventional MPEG encoding apparatus, each picture (I picture, P picture or B picture) is divided to data for each macro block (hereinafter abbreviated to “MB”), and the data of each divided MB is encoded in sequence. When data of all the MBs in the picture is completely encoded, the encoded data of those MBs is converted to data in unit of a picture and outputted as bit stream data to the exterior. In other words, the conventional MPEG encoding apparatus encodes image data in units of MB.

The MB data is quantized in accordance with an MB quantization scale code Q1 that is computed, for example, through the following three processes (target code rate setting process, imaginary buffer occupancy rate computing process, and quantization scale code computing process), i.e., the predetermined processing called TM5 (Test Mode 5) in MPEG.

(Target Code Rate Setting Process)

In the target code rate setting process, a target code rate T1 of a picture to be next encoded is set based on both a global complexity X1 and a generated code rate S1 of a picture of the same picture type, which just precedes the picture to be next encoded.

The global complexity X1 is a parameter representing the complexity of an image pattern of a picture. The generated code rate S1 represents a total data amount of encoded data actually generated with encoding of a picture.

Also, the target code rate T1 represents a target rate of the generated code rate for the picture to be next encoded.

(Imaginary Buffer Occupancy Rate Computing Process)

In the imaginary buffer occupancy rate computing process, an imaginary buffer occupancy rate d1(j) for the j-th MB (hereinafter indicated as “MB(j)” in the picture to be next encoded is computed using one of the following formulae (1) to (3) based on the target code rate T1 set in the target code rate setting process:

di(j)=di(0)+B(j−1)−((Ti×(j−1))/MB_cnt) (1)

dp(j)=dp(0)+B(j−1)−((Tp×(j−1))/MB_cnt) (2)

db(j)=db(0)+B(j−1)−((Tb×(j−1))/MB_cnt) (3)

In the above formulae (1) to (3), di(j), dp(j) and db(j) represent respective imaginary buffer occupancy rates d1(j) of the I picture, the P picture and the B picture. Also, di(0), dp(0) and db(0) represent respective imaginary buffer initial occupancy rates d1(0) of the I picture, the P picture and the B picture. B(j) represents the actually generated code rate for each of MB(1) to MB(j). Ti, Tp and Tb represent respective target code rates T1 of the I picture, the P picture and the B picture set in the target code rate setting process. Further, MB_cnt represents the total number of MBs (hereinafter referred to as the “MB number”) in one picture.

As seen from the above formulae (1) to (3), because the imaginary buffer initial occupancy rate d1(0), i.e., the first term of the right side, is constant in one picture, a change of each imaginary buffer occupancy rate d1(j) in one picture is determined by (B(j−1)−((T1×(j−1))/MB_cnt), i.e., the second and third terms of the right side. More specifically, in the third term ((T1×(j−1))/MB_cnt), the target code rate T1 is evenly assigned to each MB in the picture. Then, the difference between the second term, i.e., the actually generated code rate B(j−1), and the third term is determined. The imaginary buffer occupancy rate d1(j) is changed depending on that difference.

Thus, the imaginary buffer occupancy rate d1(j) is a value for managing, in units of MB, the difference between the target code rate T1 evenly assigned to each MB in the picture and the generated code rate B(j−1) of the actually encoded and generated data so that the target code rate T1 and the generated code rate S1 of the picture coincide with each other.

The imaginary buffer initial occupancy rate d1(0) for the first picture of each picture type is set based on corresponding one of formulae (4) to (6) given below:

di(0)=10×r/31 (4)

dp(0)=Kp×di(0) (5)

db(0)=Kb×di(0) (6)

In the formula (4), r represents a parameter, called a reaction parameter, for controlling the response speed of a feedback loop. This parameter r is set as expressed in the following formula (7) based on a target bit rate bit_rate (bits/sec) and picture_rate (frames/sec) representing the number of frames per second:

r=2×bit_rate/picture_rate (7)

Also, Kp in the formula (5) and Kb in the formula (6) represent ratios of the quantization scale codes of the P picture and the B picture to the quantization scale code of the I picture, respectively. Kp and Kb are set to respective values expressed by formulae (8) and (9) given below:

Kp=1.0 (8)

Kb=1.4 (9)

Whenever encoding of each picture is completed, the imaginary buffer initial occupancy rate d1(0) is updated based on corresponding one of formulae (10) to (12) given below:

di(0)=di(MB_cnt) (10)

dp(0)=dp(MB_cnt) (11)

db(0)=db(MB_cnt) (12)

In other words, the imaginary buffer occupancy rate d1 (MB_cnt) obtained at the completion of encoding of each picture is used as the imaginary buffer initial occupancy rate d1(0) for the next picture of the same picture type.

(Quantization Scale Code Computing Process)

In the quantization scale code computing process, the quantization scale code Q1(j) for MB(j) to be next encoded is computed from corresponding one of the following formulae (13) to (15) based on the imaginary buffer occupancy rate d1(j) set in the imaginary buffer occupancy rate computing process:

Qi(j)=(di(j)×31)/r (13)

Qp(j)=(dp(j)×31)/r (14)

Qb(j)=(db(j)×31)/r (15)

In the formulae (13) to (15), Qi(j), Qp(j) and Qb(j) represent respective quantization scale codes Q1(j) used when creating the I picture, the P picture and the B picture.

Thus, by repeating the target code rate setting process, the imaginary buffer occupancy rate computing process, and the quantization scale code computing process, the quantization scale code Q1(j) for each MB(j) (j is a value from 1 to MB_cnt) is computed and MB(j) is quantized based on the computed quantization scale code Q1(j).

Incidentally, the target code rate setting process is a process corresponding to step1 of TM5, and the imaginary buffer occupancy rate computing process and the quantization scale code computing process are processes corresponding to step2 of TM5.

In the imaginary buffer occupancy rate computing process, however, three imaginary buffers are used independently in a one-to-one relation to the three picture types as described above. As a result, the conventional MPEG encoding scheme has the following problems.

The quantization scale code Q1(j) for MB(j) is computed, as stated above, by putting, in one of the formulae (13) to (15), both the imaginary buffer occupancy rate d1(j) corresponding to the picture type of the picture to be next encoded (i.e., the imaginary buffer occupancy rate d1(j) when the picture to be next encoded is the I picture, the imaginary buffer occupancy rate dp(j) when it is the P picture, or the imaginary buffer occupancy rate db(j) when it is the B picture), and the reaction parameter r.

Respective values of the imaginary buffer occupancy rates d1(j) are changed, as described above, depending on the second term and the third term of the formulae (1) to (3).

However, a change of the imaginary buffer occupancy rate d1(j) has a close relationship with the MB type (intra block, forward predictive inter block, and bidirectionally predictive inter block).

More specifically, the intra block produces a large absolute difference depending on an image pattern between when the generated code rate is large and when it is small. In the I picture all made up of intra blocks, therefore, the imaginary buffer occupancy rate d1(j) varies to a large extent.

On the other hand, in the inter blocks, because the generated code rate is basically small, the absolute difference in the generated code rate is also small between when the generated code rate is large and when it is small. As a result, a variation of the imaginary buffer occupancy rate d1(j) is small in the P picture that is primarily made up of the forward predictive inter block, and in the B picture that includes, in addition to the forward predictive inter block, the bidirectionally predictive inter block in which the generated code rate is minimum.

Hence, a variation of the imaginary buffer occupancy rate d1(j) reduces gradually in the order of the I picture, the P picture and the B picture.

To the contrary, the reaction parameter r in the formulae (13) to (15) is a fixed value independently of the picture type.

Thus, a first problem resides in that a variation of the imaginary buffer occupancy rate d1(j) differs greatly depending on the picture type, while the reaction parameter r is a fixed value, and therefore a change rate of the quantization scale code Q1(j) greatly differs depending on the picture type.

More specifically, as described above, the imaginary buffer occupancy rate d1(j) generally varies in a larger extent in the order of the I picture, the P picture and the B picture. Therefore, when the reaction parameter r is set, for example, to provide an appropriate reaction for the quantization scale code Qi(j) of the I picture, the reaction of the quantization scale code Qb(j) of the B picture is impaired.

On the other hand, when the reaction parameter r is set to provide an appropriate reaction for the quantization scale code Qb(j) of the B picture, the quantization scale code Qi(j) of the I picture is abruptly changed, thus resulting in a too frequent change of the quantization value within the picture.

Also, the quantization scale code Q1(1) of the head MB in a certain picture is given as the same value as the quantization value Q1(MB_cnt) of the last MB in the just preceding picture of the same picture type. The picture type, however, does not always occur continuously. Hence, a second problem resides in that the quantization scale code Q1 (MB_cnt) obtained at the completion of encoding of the picture is not always appropriate as the quantization scale code Q1(1) of the head MB in the next picture of the same picture type.

Assuming, for example, that each GOP (Group of Picture) comprises 15 frames and an I picture in arbitrary GOP is encoded, in a sequence in which images abruptly change, there is a low possibility in that the quantization scale code Q1 (MB_cnt) obtained at the completion of encoding of the I picture preceding 15 frames (i.e., the T picture in the just preceding GOP) is appropriate as the quantization scale code Qi(1) of the head MB in the next I picture. Further, when the reaction parameter r is set to provide a moderate feedback loop for the I picture, a substantial number of MBs are required until the value of the quantization scale code Qi(1) of the head MB becomes the value of the quantization scale code Q1(j) appropriate for the relevant I picture.

Thus, in the conventional MPEG encoding scheme, since three imaginary buffers are used independently in a one-to-one relation to the three types of the picture to be encoded (i.e., I picture, P picture or B picture), images with stable quality cannot be provided for all the types of pictures.

### SUMMARY OF THE INVENTION

In view of the state of the art set forth above, it is an object of the present invention to provide images with stable quality for all the types of pictures.

To achieve the above object, the present invention provides a program causing a computer to execute an imaginary buffer occupancy rate computing step of computing an imaginary buffer occupancy rate for performing management such that a target code rate assigned to a first access unit including a first block to be now encoded coincides with a generated code rate of encoded data actually generated with encoding of the first access unit; and a quantization parameter computing step of computing a value of a quantization parameter, which is used when the first block is quantized, based on the imaginary buffer occupancy rate corresponding to the first block and computed by processing in the imaginary buffer occupancy rate computing step, the imaginary buffer occupancy rate computing step employing a common imaginary buffer regardless of access unit type of the first access unit.

The program may further comprise a first parameter computing step for computing a value of a first parameter regarding the access unit type of the first access unit, wherein the imaginary buffer occupancy rate computing step computes the imaginary buffer occupancy rate corresponding to the first block based on the value of the first parameter computed by processing in the first parameter computing step.

The program may further comprise a second parameter computing step for computing a value of a second parameter representing complexity of the access unit, wherein the first parameter computing step computes the value of the first parameter based on respective values of the second parameter computed by processing in the second parameter computing step and corresponding to the access units of the plural access unit types.

The second parameter computing step may compute, based on both the generated code rate of a second access unit of the predetermined access unit type, which has been encoded just before the first access unit, and a value of the quantization parameter applied to the second access unit, the value of the second parameter corresponding to the second access unit.

The first access type may be one of an intra-encoded access unit, an inter-access-unit forward predictive encoded access unit, and an inter-access-unit bidirectionally predictive encoded access unit.

The program may further comprise an initial value setting step for setting, as an initial value of the imaginary buffer occupancy rate of a third access unit to be encoded subsequent to the first access unit, the imaginary buffer occupancy rate corresponding to a second block which has been finally encoded in the first access unit.

Also, the present invention provides a recording medium storing a computer readable program, the program causing the computer to execute an imaginary buffer occupancy rate computing step of computing an imaginary buffer occupancy rate for performing management such that a target code rate assigned to a first access unit including a first block to be now encoded coincides with a generated code rate of encoded data actually generated with encoding of the first access unit; and a quantization parameter computing step of computing a value of a quantization parameter, which is used when the first block is quantized, based on the imaginary buffer occupancy rate corresponding to the first block and computed by processing in the imaginary buffer occupancy rate computing step, the imaginary buffer occupancy rate computing step employing a common imaginary buffer regardless of access unit type of the first access unit.

Further, the present invention provides an image encoding apparatus comprising an imaginary buffer occupancy rate computing unit for computing an imaginary buffer occupancy rate for performing management such that a target code rate assigned to a first access unit including a first block to be now encoded coincides with a generated code rate of encoded data actually generated with encoding of the first access unit; and a quantization parameter computing unit for computing a value of a quantization parameter, which is used when the first block is quantized, based on the imaginary buffer occupancy rate corresponding to the first block and computed by the imaginary buffer occupancy rate computing unit, the imaginary buffer occupancy rate computing unit employing a common imaginary buffer regardless of access unit type of the first access unit.

Still further, the present invention provides an image encoding method comprising the steps of an imaginary buffer occupancy rate computing step of computing an imaginary buffer occupancy rate for performing management such that a target code rate assigned to a first access unit including a first block to be now encoded coincides with a generated code rate of encoded data actually generated with encoding of the first access unit; and a quantization parameter computing step of computing a value of a quantization parameter, which is used when the first block is quantized, based on the imaginary buffer occupancy rate corresponding to the first block and computed by processing in the imaginary buffer occupancy rate computing step, the imaginary buffer occupancy rate computing step employing a common imaginary buffer regardless of access unit type of the first access unit.

In the program, the storage medium, and the image encoding apparatus and method of the present invention, the imaginary buffer occupancy rate corresponding to the first block is computed for performing management such that the target code rate assigned to the first access unit including the first block to be now encoded coincides with the generated code rate of encoded data actually generated with encoding of the first access unit. Based on the computed imaginary buffer occupancy rate, a value of the quantization parameter is computed which is used when the first block is quantized. In the imaginary buffer occupancy rate computing step, a common imaginary buffer is employed regardless of the access unit type of the first access unit.

According to the program, the storage medium, and the image encoding apparatus and method of the present invention, therefore, images with stable quality can be provided for all the types of access units (pictures).

### BRIEF DESCRIPTION OF THE DRAWINGS

FIG. 1 is a block diagram showing one example of an image encoding apparatus to which the present invention is applied;

FIG. 2 is a block diagram showing one example of hardware configuration of a rate controller in the image encoding apparatus of FIG. 1;

FIG. 3 is a block diagram showing one example of software configuration of the rate controller in the image encoding apparatus of FIG. 1; and

FIG. 4 is a flowchart for explaining processing executed by a quantization scale code control module in the rate controller of FIG. 3.

### DESCRIPTION OF THE PREFERRED EMBODIMENTS

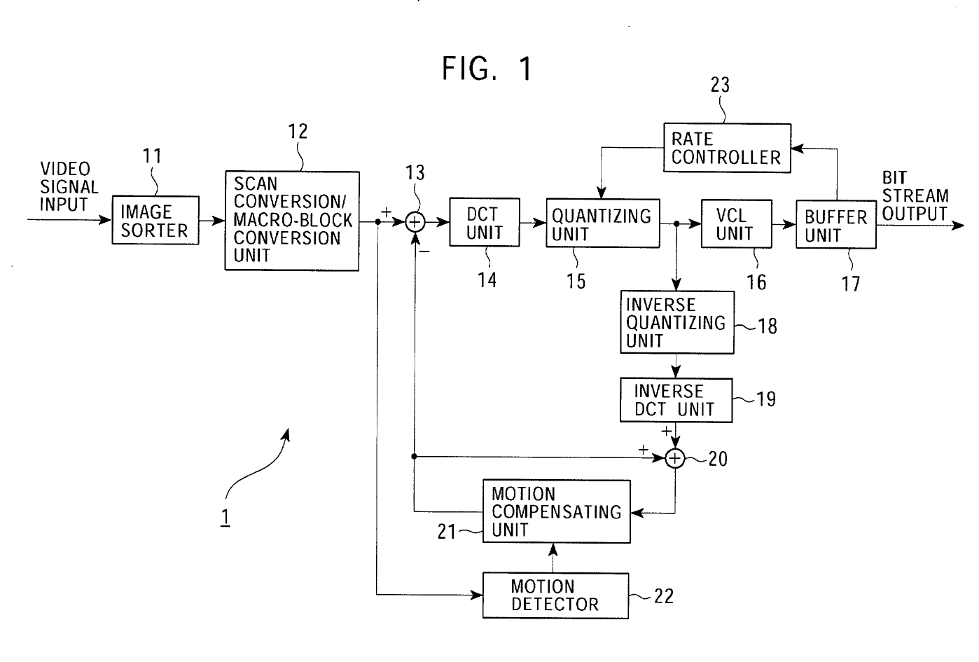

FIG. 1 shows one example of an image encoding apparatus 1 to which the present invention is applied;

The image encoding apparatus 1 is adaptable for encoding in units of frame, for example, with the MPEG scheme as described above, but encoding may be performed in units of field. In the present invention, therefore, the unit for encoding is also referred to as an “access unit”.

An image sorter 11 carries out A/D (analog-digital) conversion of a video signal supplied from the exterior, and rearranges data of each picture (I picture, P picture or B picture) in the A/D-converted digital video signal into the preset sequence in which the data is to be encoded. Then, the image sorter 11 supplies the data to a scan conversion/macro-block conversion unit 12 in accordance with the present sequence.

The scan conversion/macro-block conversion unit 12 determines whether the supplied picture data is a frame structure or a field structure, and then executes processing of scan conversion corresponding to a determined result for the supplied picture data. Also, the unit 12 converts the supplied picture data to MB (macro block) data divided in number of MBs (number of MB_cnt), and supplies the converted MB data to a subtracter 13 and a motion detector 22.

When the MB data supplied from the scan conversion/macro-block conversion unit 12 is the MB data of the I picture, the subtracter 13 supplies the MB data to a DCT unit 14 as it is (without processing the data in any way). When the supplied MB data is the MB data of the P picture or B picture, the subtracter 13 subtracts, from the MB data, predictive image data supplied from a motion compensating unit 21 (namely, adds the predictive image data in reversed polarity to the MB data), and then supplies differential data to the DCT unit 14.

The DCT unit 14 executes a DCT (Discrete Cosine Transform) process on the differential data for conversion to DCT coefficients. A quantizing unit 15 quantizes the DCT coefficients in accordance with a quantization scale code Q1 supplied from a rate controller 23, and supplies the quantized data to a VLC unit 16 and an inverse quantizing unit 18.

The VLC unit 16 executes a variable length coding process on the quantized data for conversion to VLC (Variable Length Code) and supplies the VLC to a buffer unit 17.

When the VLCs for the entire picture are supplied, the buffer unit 17 converts the VLC to data in units of picture and outputs the converted data as bit stream data. Also, the buffer unit 17 supplies the amount of VLC generated in the entire picture, i.e., a picture-generated code rate S1, to the rate controller 23.

The inverse quantizing unit 18 inverse-quantizes the quantized MB data supplied from the quantizing unit 15. An inverse DCT unit 19 executes an inverse DCT process on the inverse-quantized MB data and supplies resulting data to an adder 20.

The adder 20 adds the inverse DCT-processed MB image data and predictive image data corresponding to the relevant MB image data and supplied from the motion compensating unit 21 for restoring the original MB image data, and then supplies the original MB image data to the motion compensating unit 21 for creating predictive image data corresponding to the MB image data encoded subsequently.

The motion detector 22 detects motion vectors corresponding to the MB data supplied from the scan conversion/macro-block conversion unit 12 and supplies the detected motion vectors to the motion compensating unit 21.

The motion compensating unit 21 executes a motion compensating process based on the motion vectors supplied from the motion detector 22. More specifically, based on the motion vectors supplied from the motion detector 22, the motion compensating unit 21 reads those of image data stored therein beforehand, which correspond to the MB data supplied to the subtracter 13, and then supplies the read image data, as predictive image data, to the subtracter 13.

The rate controller 23 computes the quantization scale code Q1 based on the generated code rate S1 supplied from the buffer unit 17, and supplies the computed quantization scale code Q1 to the quantizing unit 13.

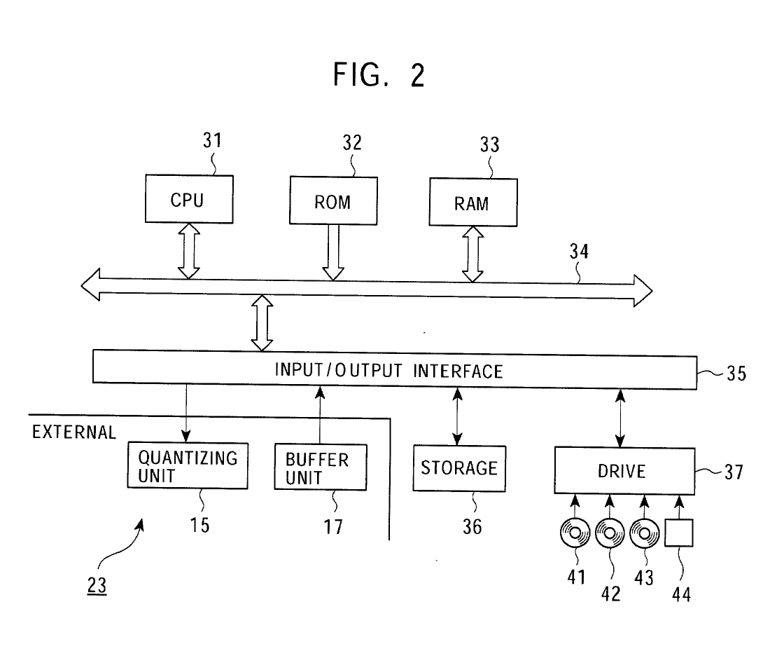

FIG. 2 is a block diagram showing one example of hardware configuration of the rate controller 23.

In FIG. 2, a CPU (Central Processing Unit) 31 executes various processes in accordance with a program stored in a ROM (Read Only Memory) 32 or a program loaded into a RAM (Random Access Memory) 33 from a storage 36.

For example, the CPU 31 computes the quantization scale code Q1 in accordance with a program for computing the quantization scale code Q1.

The RAM 33 also stores, as required, data necessary for the CPU 31 to execute the various processes, e.g., the generated code rate S1, global complexity X1, target code rate T1, and the quantization scale code Q1.

The CPU 31, the ROM 32 and the RAM 33 are connected to each other via a bus 34. An input/output interface 35 is also connected to the bus 34.

The quantizing unit 15 and the buffer unit 17, which are located on the external side (looking from the rate controller 23), are connected to the input/output interface 35. More specifically, the generated code rate S1 supplied from the buffer unit 17 is inputted to the rate controller 23 via the input/output interface 35, and the quantization scale code Q1 computed by the CPU 31 outputted from the rate controller 23 to the external quantizing unit 15 via the input/output interface 35.

Further, the storage 36, such as a hard disk, and a drive 37 are connected to the input/output interface 35 if necessary. A magnetic disk 41, an optical disk 42, a magneto-optical disk 43, a semiconductor memory 44 or the like is loaded, as required, into the drive 37. A computer program read out of the loaded disk is installed, as required, in the storage 36.

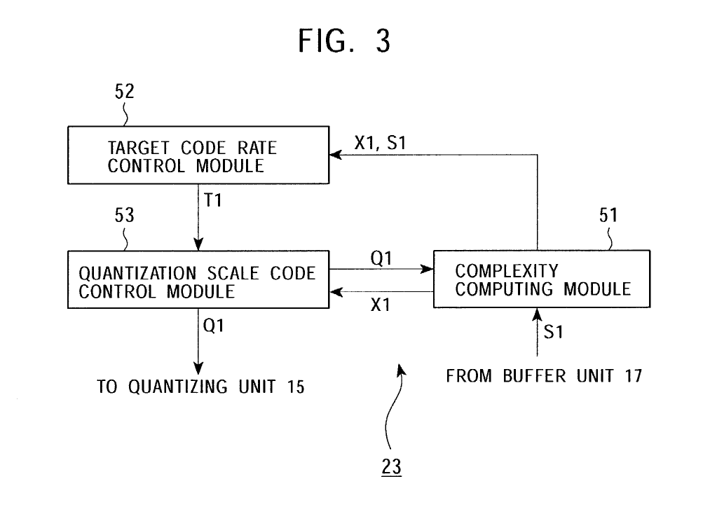

FIG. 3 shows one example of software program configuration of the rate controller 23. The software program comprises a plurality of modules. One module has one independent algorithm and executes a specific operation in accordance with the algorithm. In other words, each module is read out and executed by the CPU 31 as the occasion requires.

A complexity computing module 51 computes the global complexity X1 based on the generated code rate S1 supplied from the buffer unit 17 and the quantization scale code Q1 supplied from a quantization scale code control module 53 using one of formulae (16) to (18) given below:

Xi=Si×Qi (16)

Xp=Sp×Qp (17)

Xb−Sb×Qb (18)

The global complexity X1 is a parameter representing, as stated above, the complexity of an image pattern.

In the formulae (16) to (18), Xi, Xp and Xb represent respective global complexities X1 of the I picture, the P picture and the B picture. Si, Sp and Sb represent respective generated code rates S1 resulting from when the I picture, the P picture and the B picture are encoded in the VLC unit 16. Also, Qi, Qp and Qb represent respective quantization scale codes Q1 used when creating the I picture, the P picture and the B picture.

The complexity computing module 51 supplies the thus-computed global complexity X1 to a target code rate control module 52 and the quantization scale code control module 53, and also supplies the generated code rate S1 used in the above computing process to the target code rate control module 52.

The target code rate control module 52 sets the target code rate T1 based on the global complexity X1 and the generated code rate S1 both supplied from the complexity computing module 51, and supplies the set target code rate T1 to the quantization scale code control module 53.

In other words, the processing executed in the target code rate control module 52 corresponds to the target code rate setting process (TM5-step1) of TM5 in the MPEG encoding scheme.

The quantization scale code control module 53 computes the quantization scale code Q1 based on the target code rate T1 supplied from the target code rate control module 52 and the global complexity X1 supplied from the complexity computing module 51, and supplies the computed quantization scale code Q1 to the quantizing unit 15 and the complexity computing module 51.

In other words, the processing executed in the quantization scale code control module 53 corresponds to the imaginary buffer occupancy rate computing process and the quantization scale code computing process of TM5 (TM5-step2) in the MPEG encoding scheme.

The processing executed in the quantization scale code control module 53 can be realized, for example, using a series of software programs.

In the imaginary buffer occupancy rate computing process and the quantization scale code computing process of TM5 (TM5-step2) in the MPEG encoding scheme, the imaginary buffer required for computing the quantization scale code Q1 is prepared independently for each picture type. Thus, three different imaginary buffers are used in TM5 of the MPEG encoding scheme depending on the picture types. By contrast, in the quantization scale code control module 53 of the rate controller 23 to which the present invention is applied, as described later in detail, a common imaginary buffer (only one imaginary buffer) is used regardless of the picture type, i.e., for all the types of pictures.

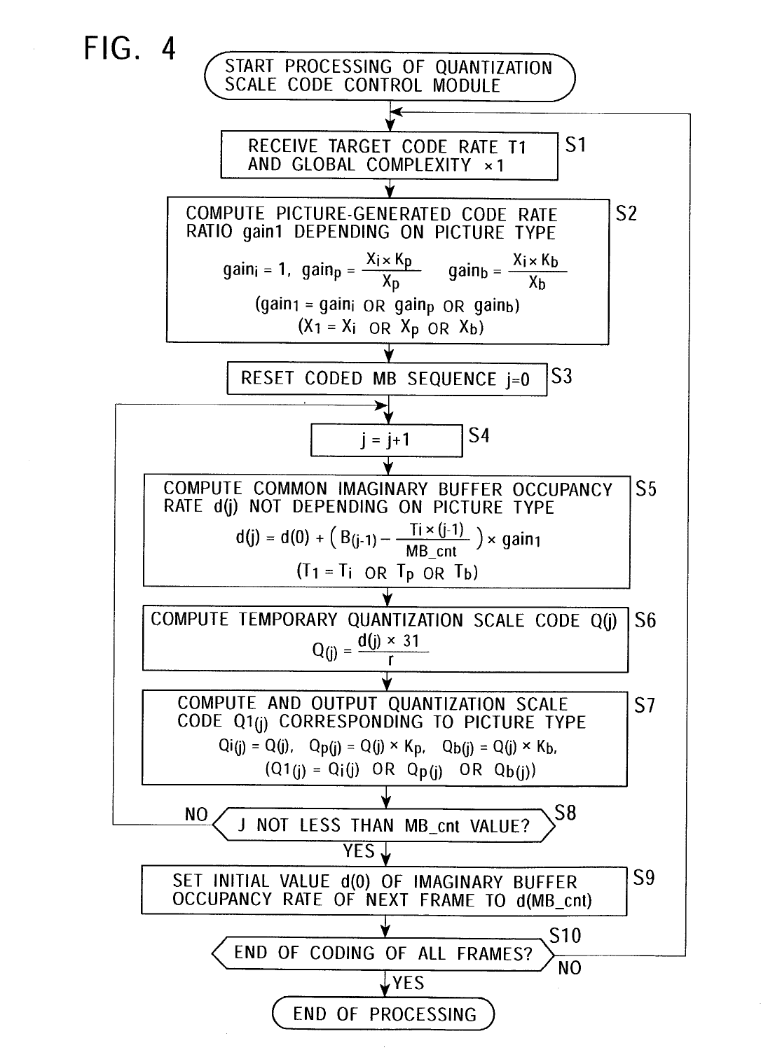

The operation of the quantization scale code control module 53 will be described below with reference to a flowchart of FIG. 4.

In a target code rate inputting step S1, the quantization scale code control module 53 receives both the global complexity X1 (i.e., X1 (=Xi, Xp and Xb) of the I picture, the P picture and the B picture just preceding the picture that is now under encoding) supplied from the complexity computing module 51, and the target code rate T1 of the picture that is now under encoding, which is supplied from the target code rate control module 52.

More specifically, the quantization scale code control module 53 receives the target code rate Ti when the picture now under encoding is the I picture, the target code rate Tp when it is the P picture, or the target code rate Tb when it is the B picture.

In a generated code rate computing step S2, the quantization scale code control module 53 computes, prior to encoding for each MB, a generated code rate ratio gain₁ of the picture now under encoding depending on the picture type of the relevant picture.

Practically, the quantization scale code control module 53 computes the generated code rate ratio gain₁ by putting the global complexity X1 received in the processing of the target code rate inputting step S1 in one of formulae (19) to (21) given below, which corresponds to the picture type of the picture now under encoding:

gainᵢ=1 (19)

gainₚ=(Xi×Kp)/Xp (20)

gain_{b}=(Xi×Kb)/Xb (21)

In the formulae (19) to (21), gain₁, gainₚ and gain_{b} represent respective generated code rate ratios gain₁ of the I picture, the P picture and the B picture. Specifically, the generated code rate ratio gain₁ is computed using the formula (19) when the picture now under encoding is the I picture, using the formula (20) when it is the P picture, and using the formula (21) when it is the B picture.

Thus, the generated code,rate ratio gain₁ is a parameter regarding the picture type, which represents a ratio of the generated code rate in the P picture or the B picture to the generated code rate of the I picture as a reference.

It is here assumed that 1.0 (formula (8)) is used as a value of Kp and 1.4 (formula (9)) is used as a value of Kb.

In a reset step S3, the quantization scale code control module 53 resets to 0 the sequence of MB to be next encoded (hereinafter referred to the “coded MB sequence J (J is any value of 1 to MB_cnt)).

In other words, the quantization scale code control module 53 counts a value of the coded MB sequence J as described later, and initializes the value of the coded MB sequence J before encoding a new picture.

In a count adding step S4, the quantization scale code control module 53 increments the count value of the coded MB sequence J by one. Stated otherwise, the quantization scale code control module 53 computes the coded MB sequence J (J after update)=J (J before update)+1, and loads (stores) a computed result in a predetermined area (hereinafter referred to as a “J area”) developed on the RAM 33.

In an imaginary buffer occupancy rate computing step S5, the quantization scale code control module 53 computes a occupancy rate d(j) of an imaginary buffer (common imaginary buffer regardless of the picture type) for the MB(j).

Stated otherwise, the quantization scale code control module 53 computes the imaginary buffer occupancy rate d(j) by putting, in a formula (22) given below, both the target code rate T1 received in the target code rate inputting step S1 and the generated code rate ratio gain₁ computed by the processing of the generated code rate computing step S2.

Japanese Unexamined Patent Application Publication No. 7-212755 discloses a rate-control technique in which sensitivity of quantization step is turned by the amplification factor. However, this prior art does not disclose what kind of parameters are used for setting the amplification factor, and does not disclose whether the amplification factor is set statically or dynamically (adjustably or the like). Thus, the amplification factor in Japanese Unexamined Patent Application Publication No. 7-212755 is clearly different from gain of the present invention.

More specifically, when the picture now under encoding is the I picture, the target code rate Ti and the generated code rate ratio gainᵢ are put in the formula (22). When it is the P picture, the target code rate Tp and the generated code rate ratio gainₚ are put in the formula (22), and when it is the B picture, the target code rate Tb and the generated code rate ratio gain_{b} are put in the formula (22).

d(j)=d(0)+(B(j−1)−T1×(j−1)/MB_cnt)×gain₁ (22)

As described above, the quantization scale code control module 53 employs the common imaginary buffer regardless of the picture type. However, if a formula corresponding to the above-stated formulae (1) to (3) (i.e., a formula obtained by omitting the third term “gain₁” of the formula (22)) is employed, it is impossible to overcome the above-mentioned first problem that a variation of the imaginary buffer occupancy rate d(j) differs greatly depending on the picture type.

In the quantization scale code control module 53, therefore, the imaginary buffer occupancy rate d(j) is properly adjusted by employing the generated code rate ratio gain₁ computed by the processing of the generated code rate computing step S2 (i.e., the generated code rate ratio gain₁ computed for each picture corresponding to the picture type of the picture now under encoding) as indicated by the third term of the formula (22). As a result, the quantization scale code control module 53 can overcome the above-stated problem.

The imaginary buffer initial occupancy rate d(0) for the picture, which is first encoded, is set by a formula (23) given below:

d(0)=10×r/31 (23)

In the formula (23), the reaction parameter r is set based on the above-mentioned formula (7).

In a temporary quantization scale code computing step S6, the quantization scale code control module 53 computes a temporary quantization scale code Q(j) of MB(j).

More specifically, the quantization scale code control module 53 computes the temporary quantization scale code Q(j) by putting, in a formula (24) given below, the imaginary buffer occupancy rate d(j) computed by the processing of the imaginary buffer occupancy rate computing step S5:

Q(j)=(d(j)×31)/r (24)

In the formula (24), the reaction parameter r is set based on the above-mentioned formula (7).

In a quantization scale code computing step S7, the quantization scale code control module 53 computes the formal quantization scale code Q1(j) of MB(j) corresponding to the picture type of MB(j), and then supplies (outputs) the computed result to both the quantizing unit 15 and the complexity computing module 51.

More specifically, the quantization scale code control module 53 computes the quantization scale code Q1(j) of MB(j) by putting the temporary quantization scale code Q(j) computed by the processing of the temporary quantization scale code computing step S6 in one of formulae (25) to (27) given below, which corresponds to the picture type of the picture now under encoding:

Qi(j)=Q(j) (25)

Qp(j)=Q(j)×Kp (26)

Qb(j)=Q(j)×Kb (27)

In the formulae (25) to (27), Qi(j), Qp(j) and Qb(j) represent respective quantization scale codes Q1(j) used when creating the I picture, the P picture and the B picture. Also, it is here assumed that 1.0 (formula (8)) is used as a value of Kp and 1.4 (formula (9)) is used as a value of Kb.

Stated otherwise, the quantization scale code Q1(j) of MB(j) is computed using the formula (25) when the picture including MB(j) to be now encoded is the I picture, using the formula (26) when it is the P picture, or using the formula (27) when it is the B picture. Then, the computed quantization scale code Q1(j) is supplied to both the quantizing unit 15 and the complexity computing module 51.

In a first determining step S8, the quantization scale code control module 53 determines whether the value of the coded MB sequence J stored in the J area is not less than the value of MB_cnt (value of the MB number). In other words, the quantization scale code control module 53 determines whether MB(j) to be now encoded is the last MB in the relevant picture.

If it is determined in the first determining step S8 that the value of the coded MB sequence J is less than the value of MB_cnt (value of the MB number) (i.e., that MB(j) is not the last MB), the quantization scale code control module 53 returns to the count adding step S4 and repeats the processing of the subsequent steps. Stated otherwise, the quantization scale code control module 53, computes the quantization scale code Q1(j+1) of MB(j+1) to be next encoded.

On the other hand, if it is determined in the first determining step S8 that the value of the coded MB sequence J is not less than the value of MB_cnt (value of the MB number) (i.e., that MB(j) is the last MB), the quantization scale code control module 53 sets in an initial value setting step S9, as an initial value d(0) of the imaginary buffer occupancy rate for the picture to be next encoded, the imaginary buffer occupancy rate d(MB_cnt) computed by the processing of the just preceding imaginary buffer occupancy rate computing step S5 (i.e., the imaginary buffer occupancy rate for the last MB in the picture encoded just before).

Thus, because the quantization scale code control module 53 employs one common imaginary buffer regardless of the picture type, the imaginary buffer occupancy rate d(MB_cnt) obtained at the completion of encoding of one picture can be used, as it is, as the imaginary buffer initial occupancy rate d(0) for a picture to be next encoded regardless of the picture type of that picture.

In a second determining step S10, the quantization scale code control module 53 determines whether coding of all the pictures is completed. If it is determined that coding of all the pictures is not yet completed, the quantization scale code control module 53 returns to the target code rate inputting step S1 and repeats the processing of the subsequent steps in order to execute the processing for the next picture. If it is determined that coding of all the pictures is completed, the processing of the flowchart is brought to an end.

As described above, the quantization scale code control module 53 can perform encoding control with one common imaginary buffer regardless of the picture type by employing, in the imaginary buffer occupancy rate computing step S5, the generated code rate ratio gain₁ computed for each picture in the processing of the generated code rate computing step S2.

Stated otherwise, the quantization scale code control module 53 computes, in the processing of the generated code rate computing step S2, the ratio gain₁ of the generated code rate of the P picture or the B picture to the generated code rate of the I picture by using the global complexity X1 for each picture, which is supplied from the complexity computing module 51.

Then, the quantization scale code control module 53 adjusts, in the processing of the imaginary buffer occupancy rate computing step S5, the magnitude of variation of the imaginary buffer occupancy rate d(j) using the value of the generated code rate ratio gain₁ so that the magnitude of the variation is substantially equal regardless of the picture type.

Further, since the magnitude of the variation is obtained on the basis of the I picture, the quantization scale code control module 53 computes, in the processing of the quantization scale code computing step S7, the quantization scale code Q1(j) for the P picture or the B picture by multiplying the value of Kp or Kb by the temporary quantization scale code Q(j) computed by the processing of the temporary quantization scale code computing step S6.

Accordingly, the quantization scale code control module 53 can perform encoding control using one imaginary buffer regardless of the picture type by carrying out a series of the processing described above, and hence can overcome the above-mentioned first problem.

In other words, the quantization scale code control module 53 is able to maintain the response speed of a feedback loop for the quantization scale code Q1(j) to be substantially constant regardless of the picture type.

Also, as a result of performing encoding control using one imaginary buffer regardless of the picture type, the quantization scale code control module 53 can use, in the processing of the initial value setting step S9, as an initial value d(0) of the imaginary buffer occupancy rate for the picture to be next encoded regardless of the picture type, the imaginary buffer occupancy rate d(MB_cnt) obtained at the completion of encoding of the preceding picture.

In other words, the quantization scale code control module 53 is able to employ the final quantization scale code of the latest picture as the quantization scale code of the head MB of the next picture regardless of the picture type. Accordingly, even in a sequence in which images are abruptly changed, the quantization scale code control module 53 is able to supply a more appropriate quantization scale code as a value for the head MB. Hence, the quantization scale code control module 53 can also overcome the above-mentioned second problem.

Thus, in the encoding apparatus 1, shown in FIG. 1, including the quantization scale code control module 53, the encoding control can be performed at the substantially constant response speed of the feedback loop for all the pictures regardless of the picture type, and too frequent changes of the quantization value can be avoided in the encoding process. As a result, when image data encoded by the encoding apparatus 1 shown in FIG. 1 is decoded, stable quality can be obtained in the whole of images on the screen.

Further, in the encoding apparatus 1, an appropriate quantization value can be set for the head MB of each frame. More specifically, in the encoding apparatus 1, even when the reaction parameter is set to such a value as providing a moderate response speed of the feedback loop, for example, in a sequence in which images are abruptly changed, the quantization value can be given with stability in the whole of images on the screen while satisfying the target code rate.

While the above-described embodiment employs DCT for conversion and encoding, the conversion scheme is not limited to a particular one, but may be, e.g., wavelet conversion, Haar conversion, or K-L conversion. Stated otherwise, the DCT unit 14 may be replaced with a conversion and encoding unit employing one of those conversion schemes.

While the above-described embodiment employs the quantization scale code as a variable for controlling quantization scale code, i.e., quantization parameter, any other suitable parameter can be used without limitations so long as it is able to control the quantization. For example, a quantization value may be used instead.

While the above-described embodiment employs, as a parameter for representing the complexity of an image pattern, the parameter resulting from multiplying the quantization scale code by the generated code rate (i.e., the global complexity X1 computed by the formula (16), (17) or (18)), any other suitable parameter can be used without limitations so long as it is able to represent the complexity of an image pattern.

While the above-described embodiment employs, as a parameter for representing control of the response speed of the feedback loop for the quantization scale code, the function expressed by the formula (7), i.e., the function made up of the target bit rate bit_rate and picture_rate representing the number of frames per second, any other suitable parameter can be used without limitations so long as it is able to represent the control of the response speed of the feedback loop for the quantization scale code.

While, in the above-described embodiment, Kp and Kb representing respective ratios of the quantization scale codes of the P picture and the B picture to the quantization scale code of the T picture are set based on the formulae (8) and (9), the values of Kp and Kb are not limited to particular ones, but may be set to any other suitable values or set based on any suitable functions, etc.

While the above-described embodiment sets the initial value d(0) of the imaginary buffer occupancy rate for each picture in the processing of the initial value setting step S9, the method of setting the initial value d(0) is not limited to a particular one, and the initial value d(0) may be set to any other suitable value or set based on any suitable function, etc.

When causing the above-described modules to execute the predetermined functions, a program constituting the software is installed from a network and a recording medium.

The recording medium can be constituted as not only a packaged medium product, which stores the program therein and is distributed separately from the apparatus body for presenting the program to users, e.g., the magnetic disk 41 (including a floppy disk), the optical disk 42 (including a CD-ROM (Compact Disk-Read Only Memory) and a DVD (Digital Versatile Disk)), the magneto-optical disk 43 (including an MD (Mini-Disk)), or the semiconductor memory 44 as shown in FIG. 2, but also the ROM 32 or a hard disk included the storage 36, which stores the program therein and is presented to users in a condition that it is previously assembled in the apparatus body.

In this specification, the steps describing the program recorded on a recording medium are processed in a time serial manner in the sequence described above. However, those steps are not always required to be processed in a time serial manner, and they may be executed in parallel or separately from each other.

Further, each module is not limited to a particular form so long as it is able to fulfill the specific function. Each module may be constituted in the form of hardware, etc. In such a case, a maker may manufacture individual hardware units corresponding to the complexity computing module 51, the target code rate control module 52 and the quantization scale code control module 53, and interconnect those units as shown in FIG. 3.

What is claimed is:

1. A program for a computer controlling an image encoding apparatus for encoding an image in units of block, said program causing said computer to execute the steps of:
an imaginary buffer occupancy rate computing step of computing an imaginary buffer occupancy rate for performing management such that a target code rate assigned to a first access unit including a first block to be now encoded coincides with a generated code rate of encoded data actually generated with encoding of said first access unit; and
a quantization parameter computing step of computing a value of a quantization parameter, which is used when said first block is quantized, based on the imaginary buffer occupancy rate corresponding to said first block and computed by processing in said imaginary buffer occupancy rate computing step,
said imaginary buffer occupancy rate computing step employing a common imaginary buffer regardless of access unit type of said first access unit.

2. A program according to claim 1, further comprising a first parameter computing step for computing a value of a first parameter regarding the access unit type of said first access unit,
wherein said imaginary buffer occupancy rate computing step computes the imaginary buffer occupancy rate corresponding to said first block based on the value of said first parameter computed by processing in said first parameter computing step.

3. A program according to claim 2, further comprising a second parameter computing step for computing a value of a second parameter representing complexity of the access unit,
wherein said first parameter computing step computes the value of said first parameter based on respective values of the second parameter computed by processing in said second parameter computing step and corresponding to the access units of the plural access unit types.

4. A program according to claim 3, wherein said second parameter computing step computes, based on both the generated code rate of a second access unit of the predetermined access unit type, which has been encoded just before said first access unit, and a value of the quantization parameter applied to said second access unit, the value of said second parameter corresponding to said second access unit.

5. A program according to claim 1, wherein said first access type is one of an intra-encoded access unit, an inter-access-unit forward predictive encoded access unit, and an inter-access-unit bidirectionally predictive encoded access unit.

6. A program according to claim 1, further comprising an initial value setting step for setting, as an initial value of the imaginary buffer occupancy rate of a third access unit to be encoded subsequent to said first access unit, the imaginary buffer occupancy rate corresponding to a second block which has been finally encoded in said first access unit.

7. A recording medium storing a computer readable program, said program being used for a computer controlling an image encoding apparatus for encoding an image in units of block, said program causing said computer to execute the steps of:
an imaginary buffer occupancy rate computing step of computing an imaginary buffer occupancy rate for performing management such that a target code rate assigned to a first access unit including a first block to be now encoded coincides with a generated code rate of encoded data actually generated with encoding of said first access unit; and
a quantization parameter computing step of computing a value of a quantization parameter, which is used when said first block is quantized, based on the imaginary buffer occupancy rate corresponding to said first block and computed by processing in said imaginary buffer occupancy rate computing step,
said imaginary buffer occupancy rate computing step employing a common imaginary buffer regardless of access unit type of said first access unit.

8. An image encoding apparatus for encoding an image in units of block, said apparatus comprising:
imaginary buffer occupancy rate computing means for computing an imaginary buffer occupancy rate for performing management such that a target code rate assigned to a first access unit including a first block to be now encoded coincides with a generated code rate of encoded data actually generated with encoding of said first access unit; and
quantization parameter computing means for computing a value of a quantization parameter, which is used when said first block is quantized, based on the imaginary buffer occupancy rate corresponding to said first block and computed by said imaginary buffer occupancy rate computing means,
said imaginary buffer occupancy rate computing means employing a common imaginary buffer regardless of access unit type of said first access unit.

9. An image encoding method for encoding an image in units of block, said method comprising the steps of:
an imaginary buffer occupancy rate computing step of computing an imaginary buffer occupancy rate for performing management such that a target code rate assigned to a first access unit including a first block to be now encoded coincides with a generated code rate of encoded data actually generated with encoding of said first access unit; and
a quantization parameter computing step of computing a value of a quantization parameter, which is used when said first block is quantized, based on the imaginary buffer occupancy rate corresponding to said first block and computed by processing in said imaginary buffer occupancy rate computing step,
said imaginary buffer occupancy rate computing step employing a common imaginary buffer regardless of access unit type of said first access unit.
